(19) United States
(12) Patent Application Publication
(10) Pub. No.: US 2009/0223573 A1
(43) Pub. Date: Sep. 10, 2009

(54) FLUID OPERATED VALVE

(76) Inventor: Michael Patrick Dixon, Victoria (AU)

Correspondence Address: BROOKS KUSHMAN P.C., 1000 TOWN CENTER, TWENTY-SECOND FLOOR, SOUTHFIELD, MI, 48075, US

(21) Appl. No.: 12/293,847

(22) PCT Filed: Mar. 20, 2007
(86) PCT No.: PCT/AU07/00361

§ 371 Date: Sep. 22, 2008

(30) Foreign Application Priority Data
Mar. 21, 2006 (AU) 2006901443

(51) Int. Cl. F16K 17/02

(52) U.S. Cl. 137/511

(57) ABSTRACT

This invention pertains to a fluid operated valve whereby the valve open or closed status is controlled by the fluid flowing in the valve. The valve geometry is such that it makes use of the fluid and the prevailing fluid flow characteristics to assert control over the period of the opening and closing events and subsequent mass discharge through the valve during these events. Valve geometry is used also to reduce the relative velocity between the valve body and the moving element as the moving element approaches the fully open or fully closed position.

This invention relates to a fluid operated valve. There are many applications for a quasi-autonomous valve where the fluid system orchestrates the timing and duration of the opening and closing events.

One application for this valve is that of a high pressure isolation system. The valve would find use with combustion chambers such as in an internal combustion engine whereby the valve allows charge up of the chamber then closes quasi autonomously upon combustion in the chamber to isolate the high pressure gas. The high pressure gas in the chamber can then be used to do work.

In the broadest aspect of the invention I provide a valve body and a movable element that has an infinite number of positions between the open and the closed positions. The movable element responds to a pressure differential across the valve to either open or close the valve.

In a further aspect of the invention I provide a valve body and a movable element that has an infinite number of positions between the open and the closed positions. The movable element responds to a pressure differential across the valve to either open or close the valve where flow characteristics of the working fluid are exploited to force movement of the moving element which alters the response time of the valve to either open or close.

In yet a further aspect of the invention I provide a valve body and a movable element that has an infinite number of positions between the open and the closed positions. The movable element responds to a pressure differential across the valve to either open or close the valve where flow characteristics of the working fluid are exploited to force movement of the moving element which alters the response time of the valve to either open or close and where flow characteristics of the working fluid are exploited to increase impedance or minimize impedance to fluid flow through the valve.

In one form of the valve the impedance to fluid flow or discharge in the open direction is minimized by having the movable element form a streamlined shape with a stationary outer stator which is attached to the valve body. The movable element is guided by a guide spigot. In the opposite direction i.e. over the closing period the fluid flow or discharge encounters increased impedance. Over the closing period the stator presents an array of bluff bodies to the on coming flow and secondly the movable element at all positions other than fully open forms a discontinuous surface, that is, a bluff surface with the fixed stator. The stator consists of a series of geometric shapes that resemble curved pyramids (or polyhedrons) the apex end of which presents to the open flow direction. Flow in the opposite direction impinges on the bases of these pyramids i.e. the array of bluff bodies. Integral to the stator is a series of curved surfaces so that there is a curved surface and a corresponding pyramid as an element in the array of several elements making a circular array in plan view. When the movable element is in the fully open position it along with the curved surfaces presents in cross-section an elliptic or streamlined shape which minimizes impedance to flow in the open direction. With the movable element in any other position the annular array of curved surfaces remains fixed as part of the stator and a cross-section of the movable element presents as sharp edged having left the streamlining curved surface with the stator.

The flow area along the flow path of the valve is varied so that flow effects can be utilized to maximize the pressure difference from the high-pressure side to the low-pressure side of the valve causing the valve to close as rapidly as possible. The seat area of the movable element protrudes out a small distance from the movable element.

The seat area of the valve body is recessed a small distance into the valve body so that when the seating surfaces are nearly closed a small reservoir of fluid is contained between the two seating surfaces. By the time the fluid is discharged out of this reservoir the closing velocity has been substantially reduced.

An explanation on how flow characteristics and the stator of bluff bodies is used to increase impedance to flow in the closing direction of the valve is now given. When a sufficient pressure differential is rapidly applied across the valve as like a combustion event or a step function pressure application just up stream of the valve with the movable element not in the closed position fluid flow commences at a rapid rate which gives rise to a shock front forming in the fluid. The time evolution of the establishing flow is complex and is a transient flow phenomenon. The flow evolution is also altered by the moving boundary presented to the flow by the movable element.

The shock front arrives or forms very rapidly at the entrance of the valve traveling at some velocity. The entrance and exit of the valve is dependant on the direction the fluid is flowing. The shock front is very steep and can be seen as a step function of pressure at some position along the valve fluid flow path. Ahead of the shock front and indeed extremely close the shock front the fluid is undisturbed by the front. This means that such a front in a compressible flow situation could pass almost completely through the valve without mass discharge occurring through the valve.

At some position in the travel of the shock front as it traverses through the valve it arrives at the leading surface of the moving element. The pressure multiplied by the area (i.e. pressure generated forces) summation above (i.e. shock side at this stage) and below the movable element will show a net force which will start to accelerate the valve in a direction of closing. The inertia of the movable element is such that the front would pass through the valve without any appreciable movement of the element towards closing. However the shock front strikes the bluff bodies i.e. the bases of the array of inverted pyramids integral to the stator and is partially reflected back along the valve body. This also causes disturbance to the flow through the flow area adjacent to the bluff bodies.

The general disturbance to the flow brought about by the shock front striking the bluff bodies causes a complex of events to occur. One of which is: it causes the upstream pressure to increase and therefore the pressure on the upper side of the movable element to increase which increases the acceleration and therefore the velocity of the element towards closing. It also causes the flow discharge through the flow areas adjacent to the bluff bodies to decrease which lowers the discharge downstream of the bluff bodies. The net effect is that the movable element will be traveling faster for a given mass discharge through the valve for any period up to the point of closing than would be the case if the bluff bodies were not there. The significance of a higher velocity closing event is understood in two ways. Firstly the shorter the period of closing the shorter the period of mass discharge. The second point of significance is that a moving element traveling at a higher velocity opens up volume behind it at faster rate so that some of the oncoming flow fills this volume. The mass that fills this just mentioned volume would otherwise discharge through the valve i.e. the valves mass capacitance relative to the mass discharge increases as the movable element velocity increases. If the moving element could travel fast enough no mass would pass through the valve whilst closing.

Adding to the drop in flow discharge is the additional sharp edged surface integral to the stator being exposed to the flow as the movable element moves towards closing.

In order to enhance the pressure difference from the upper surface to the lower surface of the movable element, the flow area along the flow path from the stator converges to a minimum at some position on the lower surface (e.g. at the seat inner diameter) and diverges from then on to the exit. This region of the valve can be seen as a convergent divergent nozzle. By enforcing such a geometry, flow through the valve after the shock front has passed the stator allows the pressure difference to be maximized for pressure ratios across the valve as high as about 0.8 (the pressure ratio is the ratio of the pressure at the valve exit to the pressure at the valve entry). For pressure ratios below 0.8 a standing shock front will be positioned somewhere between the throat and the exit with the best situation in terms of pressure difference being a standing shock front positioned at the exit.

To ensure that impact at closing or opening does not present as a problem, a protruding volume of the movable element enters a recessed volume of the body to form a reservoir. The side clearances are proportioned so as to retard fluid flow out of the diminishing reservoir formed by the dynamic mating of these volumes. Fluid is discharged out of the diminishing reservoir at a varying pressure. The summation of the pressure multiplied by the volume of the discharged fluid is the work done in slowing the moving element.

If material properties allow for a degree of impact stress generation on closing then the seat area can be proportioned so that the quotient of the mass of the movable element to the seat area is sufficiently low given the lower the quotient the lower the near closed velocity. Mathematical modeling has suggested that with a quotient value of about 22 or less impact stresses should be low. Having a diminishing reservoir as described in the previous paragraph may not be necessary.

The fluid passing through the valve can be compressible or incompressible. The pressure differential across the valve can be any magnitude.

In this specification the stator is said to have an array of polyhedrons to form bluff bodies to increase flow impedance of the valve however there may be several arrays of bluff bodies or bluff bodies chaotically positioned if necessary or the deployment of any system which holds up or impedes or disrupts the fluid flow allowing the velocity of the movable element to increase relative to mass discharged through the valve thereby diminishing discharge during closing. The bluff bodies can have any form.

Dynamic control surfaces either on the valve body or on the moving element can be deployed to attain the required response time and mass discharge characteristics. The control surfaces can be altered by the internal fluid flow or through external means.

Mechanical closing or opening assistance internal or external to the valve can be deployed if necessary. Mechanical here means piezoelectric, magnetic, electromagnetic, hydraulic, pneumatic, cam driven, induced magnetic fields.

In this specification the movable element was described as being guided by a guide spigot it is understood that the movable element requires correct alignment of its geometry with the geometry of the valve body and this can be achieved in many ways. The way in which the movable element is guided is not germane to this invention.

It is understood that any cavity formed between the body and the movable element, or any other elements which attach to the movable element or body, in which to trap fluid in order for this fluid to be pumped out under pressure as the cavity volume decreases upon closing for the purposes of braking the movable element can be deployed without departing from the spirit and scope of the invention. It is understood that the stator along with the bluff bodies can be omitted under some flow conditions. In one form the movable element then forms a streamlined body which presents to the fluid flow at all times during opening and closing.

In another form of the invention the movable element does not impede flow during opening but impedes flow during closing. This can be achieved by placing various flow disturbing surfaces such as turbulence trips, flow separation trips and vortex generating surfaces that act most predominately on the fluid during flow through the valve whilst the valve is closing. These flow disturbing surfaces can be placed on either the movable element or the valve body or both.

Whilst in this specification I have described a specific form of the invention, it will be understood that a person skilled in the art of fluid dynamics or engineering can well present variations in some of these aspects without departing from the spirit and scope of the invention.

1. A valve consisting of a valve body and a moving element where a pressure differential across the valve determines the position of the moving element.

2. A valve where a pressure differential across the valve determines the open or closed status of the valve.

3. A valve where flow in a preferred direction is not inhibited.

4-26. (canceled)
